(19) United States
(12) Patent Application Publication
(10) Pub. No.: US 2022/0172703 A1
(43) Pub. Date: Jun. 2, 2022

(54) ACOUSTIC MODEL LEARNING APPARATUS, METHOD AND PROGRAM AND SPEECH SYNTHESIS APPARATUS, METHOD AND PROGRAM

(71) Applicant: AI, Inc., Tokyo (JP)

(72) Inventors: Noriyuki MATSUNAGA, Souraku-gun (JP); Yamato OHTANI, Souraku-gun (JP)

(21) Appl. No.: 17/673,921

(22) Filed: Feb. 17, 2022

Related U.S. Application Data
(63) Continuation of application No. PCT/JP2020/030833, filed on Aug. 14, 2020.

(30) Foreign Application Priority Data
Aug. 20, 2019 (JP) 2019-150193

(51) Int. Cl. G10L 13/047; G10L 19/16; G10L 25/30

(52) U.S. Cl. CPC G10L 13/047; G10L 25/30; G10L 19/16

(57) ABSTRACT

A technique for synthesizing speech based on DNN that is modeled low-latency and appropriately in limited computational resource situations is presented. An acoustic model learning apparatus includes a corpus storage unit configured to store natural linguistic feature sequences and natural speech parameter sequences, extracted from a plurality of speech data, per speech unit; a prediction model storage unit configured to store a feed-forward neural network type prediction model for predicting a synthesized speech parameter sequence from a natural linguistic feature sequence; a prediction unit configured to input the natural linguistic feature sequence and predict the synthesized speech parameter sequence using the prediction model; an error calculation device configured to calculate an error related to the synthesized speech parameter sequence and the natural speech parameter sequence; and a learning unit configured to perform a predetermined optimization for the error and learn the prediction model; wherein the error calculation device configured to utilize a loss function for associating adjacent frames with respect to the output layer of the prediction model.

### TECHNICAL FIELD

The invention relates to techniques for synthesizing text to speech.

### BACKGROUND

A speech synthesis technique based on Deep Neural Network (DNN) is used as a method of generating a synthesized speech from natural speech data of a target speaker. This technique includes a DNN acoustic model learning apparatus that learns a DNN acoustic model from the speech data and a speech synthesis apparatus that generates the synthesized speech using the learned DNN acoustic model.

Patent Document 1 discloses a technique for learning a DNN acoustic model with a small size synthesizing speech of a plurality of speakers at low cost. In general, DNN speech synthesis uses Maximum Likelihood Parameter Generation (MLPG) and Recurrent Neural Network (RNN) to model temporal sequences of speech parameters.

### RELATED ART

### Patent Documents

Patent document 1: JP 2017-032839 A

### SUMMARY

### Technical Problem

However, MLPG is not suitable for low-latency speech synthesis, because the MLPG process requires utterance-level processing. In addition, RNN generally uses Long Short Term Memory (LSTM)-RNN performing high, but LSTM-RNN performs recursive processing. The recursive process is complex and has high computational costs. LSTM-RNN is not recommended in limited computational resource situations.

Feed-Forward Neural Network (FFNN) is appropriate for low-latency speech synthesis processing in limited computational resource situations. Since FFNN is a basic DNN with simplified structures that reduces computational costs and works on a frame-by-frame basis, FFNN is suitable for low-latency processing.

On the other hand, FFNN has a limitation that cannot properly model temporal speech parameter sequences, because FFNN trains to ignore relationships between speech parameters in adjacent frames. In order to solve this limitation, a learning method for FFNN that considers the relationships between speech parameters in adjacent frames is required.

One or more embodiments of the instant invention focus on solving such a problem. An object of the invention is to provide a technique for synthesizing speech based on DNN that is modeled low-latency and is appropriate in limited computational resource situations.

### Solution to Problem

The first embodiment is an acoustic model learning apparatus. The apparatus includes a corpus storage unit configured to store natural linguistic feature sequences and natural speech parameter sequences, extracted from a plurality of speech data, per speech unit; a prediction model storage unit configured to store a feed-forward neural network type prediction model for predicting a synthesized speech parameter sequence from a natural linguistic feature sequence; a prediction unit configured to input the natural linguistic feature sequence and predict the synthesized speech parameter sequence using the prediction model; an error calculation device configured to calculate an error related to the synthesized speech parameter sequence and the natural speech parameter sequence; and a learning unit configured to perform a predetermined optimization for the error and learn the prediction model; wherein the error calculation device is configured to utilize a loss function for associating adjacent frames with respect to the output layer of the prediction model.

The second embodiment is the apparatus of the first embodiment, wherein the loss function comprises at least one of loss functions relating to a time-Domain constraint, a local variance, a local variance-covariance matrix or a local correlation-coefficient matrix.

The third embodiment is the apparatus of the second embodiment, wherein the loss function comprises at least one of loss functions relating to a time-Domain constraint, a local variance, a local variance-covariance matrix or a local correlation-coefficient matrix.

The fourth embodiment is the apparatus of the third embodiment, wherein the loss function further comprises at least one of loss functions relating to a variance in sequences, a variance-covariance matrix in sequences or a correlation-coefficient matrix in sequences.

The fifth embodiment is an acoustic model learning method. The method includes inputting a natural linguistic feature sequence from a corpus that stores natural linguistic feature sequences and natural speech parameter sequences, extracted from a plurality of speech data, per speech unit; predicting a synthesized speech parameter sequence using a feed-forward neural network type prediction model for predicting the synthesized speech parameter sequence from the natural linguistic feature sequence; calculating an error related to the synthesized speech parameter sequence and the natural speech parameter sequence; performing a predetermined optimization for the error; and learning the prediction model; wherein calculating the error utilizes a loss function for associating adjacent frames with respect to the output layer of the prediction model.

The sixth embodiment is an acoustic model learning program executed by a computer. The program includes a step of inputting a natural linguistic feature sequence from a corpus that stores natural linguistic feature sequences and natural speech parameter sequences, extracted from a plurality of speech data, per speech unit; a step of predicting a synthesized speech parameter sequence using a feed-forward neural network type prediction model for predicting the synthesized speech parameter sequence from the natural linguistic feature sequence; a step of calculating an error related to the synthesized speech parameter sequence and the natural speech parameter sequence; a step of performing a predetermined optimization for the error; and a step of learning the prediction model; wherein the step of calculating the error utilizes a loss function for associating adjacent frames with respect to the output layer of the prediction model.

The seventh embodiment is a speech synthesis apparatus. The speech synthesis apparatus includes a corpus storage unit configured to store linguistic feature sequences of a text to be synthesized; a prediction model storage unit configured to store a feed-forward neural network type prediction model for predicting a synthesized speech parameter sequence from a natural linguistic feature sequence, the prediction model is learned by the acoustic model learning apparatus of the first embodiment; a vocoder storage unit configured to store a vocoder for generating a speech waveform; a prediction unit configured to input the linguistic feature sequences and predict synthesized speech parameter sequences utilizing the prediction model; and a waveform synthesis processing unit configured to input the synthesized speech parameter sequences and generates synthesized speech waveforms utilizing the vocoder.

The eighth embodiment is a speech synthesis method. The speech synthesis method includes inputting linguistic feature sequences of a text to be synthesized; predicting synthesized speech parameter sequences utilizing a feed-forward neural network type prediction model for predicting a synthesized speech parameter sequence from a natural linguistic feature sequence, the prediction model is learned by the acoustic model learning method of the fifth embodiment; inputting the synthesized speech parameter sequences; and generating synthesized speech waveforms utilizing a vocoder for generating a speech waveform.

The ninth embodiment is a speech synthesis program executed by a computer. The speech synthesis program includes a step of inputting linguistic feature sequences of a text to be synthesized; a step of predicting synthesized speech parameter sequences utilizing a feed-forward neural network type prediction model for predicting a synthesized speech parameter sequence from a natural linguistic feature sequence, the prediction model is learned by the acoustic model learning program of the sixth embodiment; a step of inputting the synthesized speech parameter sequences; and a step of generating synthesized speech waveforms utilizing a vocoder for generating a speech waveform.

### Advantage

One or more embodiments provide a technique for synthesizing speech based on DNN that is modeled low-latency and appropriately in limited computational resource situations.

### BRIEF DESCRIPTION OF DRAWINGS

FIG. 1 is a block diagram of a model learning apparatus in accordance with one or more embodiments.

FIG. 2 is a block diagram of an error calculation device in accordance with one or more embodiments.

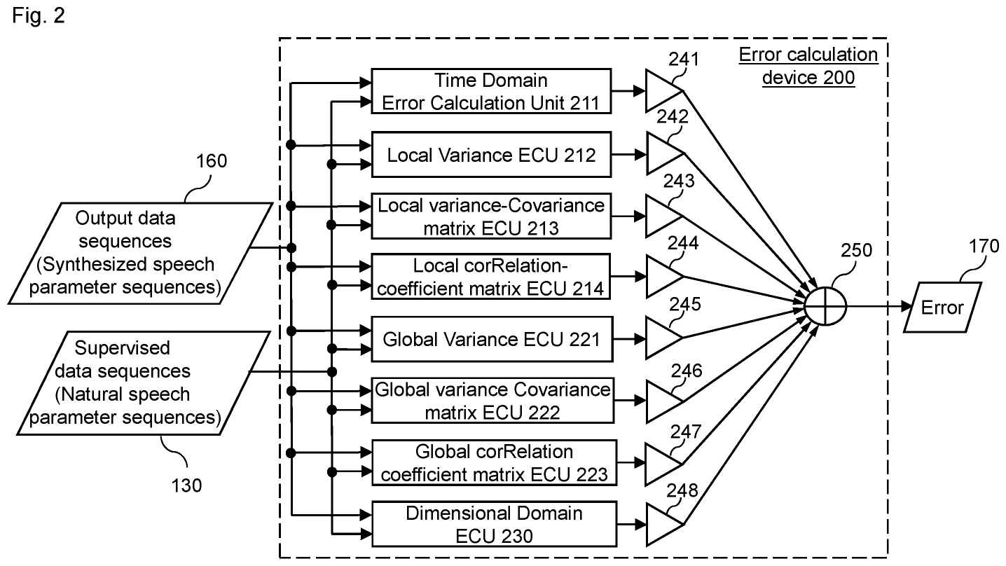

FIG. 3 is a block diagram of a speech synthesis apparatus in accordance with one or more embodiments.

FIG. 4 shows examples of fundamental frequency sequences of one utterance utilized in a speech evaluation experiment.

FIG. 5 shows examples of the 5th and 10th mel-cepstrum sequences utilized in a speech evaluation experiment.

FIG. 6 shows examples of scatter diagrams of the 5th and 10th mel-cepstrum sequences utilized in a speech evaluation experiment.

FIG. 7 shows examples of modulation spectra of the 5th and 10th mel-cepstrum sequences utilized in a speech evaluation experiment.

### DETAILED DESCRIPTION OF EMBODIMENTS

One or more embodiments of the invention are described with reference to the drawings. The same reference numerals are given to common parts in each figure, and duplicate description is omitted. There are shapes and arrows in the drawings. Rectangle shapes represent processing units, parallelogram shapes represent data, and cylinder shapes represent databases. Solid arrows represent the flows of the processing unit and dotted arrows represents the inputs and outputs of the databases.

Processing units and databases are functional blocks, are not limited to be implemented in hardware, may be implemented on the computer as software, and the form of the implementation is not limited. For example, the functional blocks may be implemented as software installed on a dedicated server connected to a user device (Personal computer, etc.) via a wired or wireless communication link (Internet connection, etc.), or may be implemented using a so-called cloud service.

### A. Overview of Embodiments

In the embodiment, a process of calculating the error of the feature amounts of the speech parameter sequences in the short-term and long-term segments are performed, when training (hereinafter referred to as “learning”) a DNN prediction model (or DNN acoustic model) for predicting speech parameter sequences. And a speech synthesis process is performed by a vocoder. The embodiment enables speech synthesis based on DNN that is modeled low-latency and is appropriate in limited computational resource situations.

### a1. Model Learning Process

Model learning processes relate to learning a DNN prediction model for predicting speech parameter sequences from linguistic feature sequences. The DNN prediction model utilized in the embodiment is a prediction model of Feed-Forward Neural Network (FFNN) type. The data flows one way in the model.

When the model is learned, a process of calculating the error of the feature amounts of the speech parameter sequences in the short-term and long-term segments is performed. The embodiment introduces a loss function into the error calculation process. The loss function associates adjacent frames with respect to the output layer of the DNN prediction model.

### a2. Text-to-Speech Synthesis Process

In the Text-to-speech (TTS) synthesis process, synthesized speech parameter sequences are predicted from predetermined linguistic feature sequences using the learned DNN prediction model. And a synthesized speech waveform is generated by a neural vocoder.

### B. Examples of Model Learning Apparatus

### b1. Functional Blocks of the Model Learning Apparatus 100

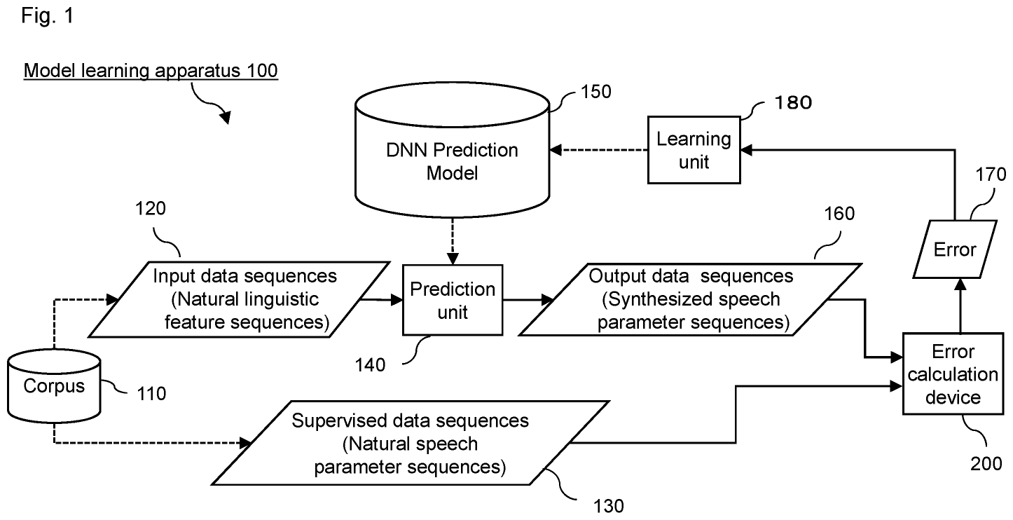

FIG. 1 is a block diagram of a model learning apparatus in accordance with one or more embodiments. The model learning apparatus 100 includes a corpus storage unit 110 and a DNN prediction model storage unit 150 (hereinafter referred to as “model storage unit 150”) as databases. The model learning apparatus 100 also includes a speech parameter sequence prediction unit 140 (hereinafter referred to as “prediction unit 140”), an error calculation device 200 and a learning unit 180 as processing units.

First, speech data of one or more speakers is recorded in advance. In the embodiment, each speaker reads aloud (or utters) about 200 sentences, the speech data is recorded, and speech dictionaries are created for each speaker. Each speech dictionary is given a speaker Identification Data (speaker ID).

In each speech dictionary, contexts, speech waveforms and natural acoustic feature amounts (hereinafter referred to as “natural speech parameters”) extracted from the speech data, are stored per speech unit. The speech unit means each of the sentences (or each of utterance-levels). Contexts (also known as “linguistic feature sequences”) are the result of text analysis of each sentence and are factors that affect voice waveforms (phoneme arrangements, accents, intonations, etc.). Speech waveforms are waveforms in which speakers read each sentence aloud and are input into a microphone.

Acoustic features (hereinafter referred to as “speech features” or “speech parameters”) include spectral features, fundamental frequencies, periodic and aperiodic indicators, and Voice/unvoice determination flags. Spectral features include mel-cepstrum, Linear Predictive Coding (LPC) and Line Spectral Pairs (LSP).

DNN is a model representing a one-to-one correspondence between inputs and outputs. Therefore, DNN speech synthesis needs to set the correspondences (or phoneme boundaries) of the speech feature sequences per frame and the linguistic feature sequences of phoneme units in advance and prepare a pair of speech features and linguistic features per frame. This pair corresponds to the speech parameter sequences and the linguistic feature sequences of the embodiment.

The embodiment extracts natural linguistic feature sequences and natural speech parameter sequences from the speech dictionary, as the linguistic feature sequences and the speech parameter sequences. The corpus storage unit 110 stores input data sequences (natural linguistic feature sequences) 120 and supervised (or training) data sequences (natural speech parameter sequences) 130, extracted from a plurality of speech data, per speech unit.

The prediction unit 140 predicts the output data sequences (synthesized speech parameter sequences) 160 from the input data sequences (natural linguistic feature sequences) 120 using the DNN prediction model stored in the model storage unit 150. The error calculation device 200 inputs the output data sequences (synthesized speech parameter sequences) 160 and the supervised data sequences (natural speech parameter sequences) 130 and calculates the error 170 of the feature amounts of the speech parameter sequences in the short-term and long-term segments.

The learning unit 180 inputs the error 170, performs a predetermined optimization (such as, Error back propagation algorithm) and learns (or updates) the DNN prediction model. The learned DNN prediction model is stored in the model storage unit 150.

Such an update process (or training process) is performed on all of the input data sequences (natural linguistic feature sequences) 120 and the supervised data sequences (natural speech parameter sequences) 130 stored in the corpus storage unit 110.

### C. Examples of Error Calculation Device

### c1. Functional Blocks of Error Calculation Device 200

The error calculation device 200 inputs the output data sequences (synthetic speech parameter sequences) 160 and the supervised data sequences (natural speech parameter sequences) 130 and executes calculations on a plurality of error calculation units (from 211 to 230) that calculate the errors of the speech parameter sequences in the short-term and long-term segments. The outputs of the error calculation units (from 211 to 230) are weighted between 0 and 1 by weighting units (from 241 to 248). The outputs of the weighting units (from 241 to 248) are added by an addition unit 250. The output of the addition unit 250 is the error 170.

Error calculation units (from 211 to 230) are classified into 3 general groups. The 3 general groups are Error Calculation Units (hereinafter referred to as “ECUs”) relating to short-term segments, long-term segments, and dimensional domain constraints.

The ECUs relating to the short-term segments include an ECU 211 relating to feature sequences of Time-Domain constraints (TD), an ECU 212 relating to the Local Variance sequences (LV), an ECU 213 relating to the Local variance-Covariance matrix sequences (LC) and an ECU 214 relating to Local corRelation-coefficient matrix sequences (LR). The ECUs for the short-term segments may be at least one of 211, 212, 213 and 214.

The ECUs relating to the long-term segments include an ECU 221 relating to Global Variance in the sequences (GV), an ECU 222 relating to Global variance-Covariance matrix in the sequences (GC), and an ECU 223 relating to the Global corRelation-coefficient matrix in the sequences (GR). In the embodiment, the sequences mean all of utterances uttering one sentence. “Global Variance, Global variance-Covariance matrix and Global corRelation-coefficient matrix in the sequences” is also called “Global Variance, Global Variance-Covariance Matrix and Global corRelation-coefficient matrix in all of the utterances”. As described later, the ECUs relating to the long-term segments may not be required, or may be at least one of 221, 222 and 223, since the loss function of the embodiment is designed such that explicitly defined short-term relationships between the speech parameters implicitly propagate to the long-term relationships.

The ECU relating to the dimensional domain constraints is an ECU 230 relating to feature sequences of Dimensional-Domain constraints. In the embodiment, the features relating to the Dimensional-Domain constraints refer to multiple dimensional spectral features (mel-cepstrum, which is a type of spectrum), rather than a one-dimensional acoustic feature such as the fundamental frequency (f₀). As described later, the ECU relating to the dimensional domain constraints may not be required.

### c2. Sequences and Loss Functions Utilized in Error Calculation

x=[x₁^{T}, . . . , xₜ^{T}, x_{T}^{T}]^{T} are the natural linguistic feature sequences (input data sequences 120). Two invert matrixes shown as “T of the upper character” are used in both inside and outside of the vector, in order to consider time information. In addition, “t and T of subscript characters” are respectively a frame index and the total frame length. The frame period is about 5 ms. The loss function is used to teach the DNN the relationships between speech parameters in adjacent frames and can be operated regardless of the frame period.

Y=[y₁^{T}, . . . , yt^{T}, y_{T}^{T}]^{T} are the natural speech parameter sequences (supervised data sequences 130). y\hat{ }=[y\hat{ }₁^{T}, . . . , y\hat{ }ₜ^{T}, y\hat{ }_{T}^{T}]^{T} are the synthesized speech parameter sequences (output data sequences 160). Originally, the hat symbol “\hat{ }” is described above “y”, however “y” and “\hat{ }” are described side by side for the convenience of the character code that can be used in the specification.

xₜ=[xₜ₁, . . . , xₜᵢ, . . . , x_{tI}] and yₜ=[yₜ₁, . . . , y_{td}, . . . , y_{tD}] are linguistic feature vectors and speech parameter vectors at frame t. Here, “i and I of subscript characters” are respectively an index and the total number of dimensions of the linguistic feature vector, and “d and D of subscript characters” are respectively the indexes and total number of dimensions of the speech parameter vector.

In the loss function of the embodiment, sequences X and Y=[Yₜ, . . . , Y_{τ}, . . . , Y_{T}] that are separated x and y by a closed interval [t+L, t+R] of the short-term segment are respectively the inputs and outputs of the DNN. Here, Yₜ=[y_{t+L}, . . . , y_{t+τ}, . . . , y_{t+R}] is a short-term segment sequence at frame t, L (≤0) is a backward lookup frame count, R (≥0) is a forward lookup frame count, and τ (L≤τ≤R) is a short-term lookup frame index.

In FFNN, y\hat{ }_{t+τ} corresponding to x_{t+τ} is independently predicted regardless of the adjacent frames. Therefore, we introduce loss functions of Time-Domain attribute (TD), Local variance (LV), Local variance-Covariance matrix (LC), and Local corRelation-coefficient matrix (LR) in order to relate adjacent frames in Yₜ (also called as “output layer”). The effects of the loss functions propagate all frames in the learning phase because Yₜ and Y_{t+τ} overlap. The loss functions allow FFNN to learn short-term and long-term segments similar to LSTM-RNN.

In addition, the loss function of the embodiment is designed such that explicitly defined short-term relationships between the speech parameters implicitly propagate to the long-term relationships. However, introducing loss functions of the Global Variance in the sequences (GV), the Global variance-Covariance matrix in the sequences (GC) and the Global corRelation-coefficient matrix in the sequences (GR) is able to explicitly define the long-term relationships.

Furthermore, for multiple dimensional speech parameters (such as spectrum), introducing Dimensional-Domain constraints (DD) is able to consider the relationships between dimensions.

The loss functions of the embodiment are defined by the weighted sum of the outputs of the loss functions as the equation (1):

$$\begin{matrix}[ Equation 1 ] & \\ L ( Y , \hat{Y} ) = {\sum }_{i} {ω}_{i} {L}_{i} ( Y , \hat{Y} ) & ( 1 )\end{matrix}$$

where i={TD, LV, LC, LR, GV, GC, GR, DD} represents the identifiers of the loss functions, and uoi is the weight to the loss of the identifier i.

(c3. Error Calculation Units from 211 to 230)

The ECU 211 relating to feature sequences of Time-Domain constraints (TD) is described. Y_{TD}=[Y₁^{T}W, . . . , Yₜ^{T}W, . . . , Y_{T}^{T}W] are sequences of features representing the relationship between each frame in the closed interval [t+L, t+R]. Time domain constraints loss function LTD (Y, Y\hat{ }) is defined as the mean squared error of the difference between Y_{TD} and Y\hat{ }_{TD} as the equation (2).

$$\begin{matrix}[ Equation 2 ] & \\ {L}_{TD} ( Y , \hat{Y} ) = \frac{1}{TMD} {\sum }_{t = 1}^{T} {\sum }_{m = 1}^{M} {\sum }_{d = 1}^{D} {( {Y}_{TD} - {\hat{Y}}_{TD} )}^{2} & ( 2 )\end{matrix}$$

where W=[W₁^{T}, . . . , Wₘ^{T}, . . . , W_{M}^{T}] is a coefficient matrix that relates adjacent frames in the closed interval [t+L, t+R], Wₘ=[W_{mL}, . . . , Wₘ₀, . . . , W_{mR}] is the mth coefficient vector, m and M are an index and the total number of coefficient vectors, respectively.

The ECU 212 relating to the Local Variance sequences (LV) is described. Y_{LV}=[v₁^{T}, . . . , vₜ^{T}, . . . . , v_{T}^{T}]^{T} is a sequence of variance vectors in the closed interval [t+L,t+R], and the local variance loss function L_{LV} (Y,Y\hat{ }) is defined as the mean absolute error of the difference between Y_{LV} and Y\hat{ }_{LV} as the equation (3).

$$\begin{matrix}[ Equation 3 ] & \\ {L}_{TD} ( Y , \hat{Y} ) = \frac{1}{TMD} {\sum }_{t = 1}^{T} {\sum }_{d = 1}^{D} [ {Y}_{LV} - {\hat{Y}}_{LV} ] & ( 3 )\end{matrix}$$

where vₜ=[vₜ₁, . . . , v_{td}, . . . , v_{tD}] is a D-dimensional variance vector at frame t and v_{td} is the dth variance at frame t given as the equation (4).

$$\begin{matrix}[ Equation 4 ] & \\ {v}_{td} = \frac{1}{- L + R + 1} {\sum }_{r = L}^{R} {( {y}_{( t + r ) d} - {y}_{td} )}^{2} & ( 4 )\end{matrix}$$

where y _{td} is the dth mean in the closed interval [t+L, t+R] given as the equation (5). Originally, the overline “¬” is described above “y”, however “y” and “¬” are described side by side for the convenience of the character code that can be used in the specification.

$$\begin{matrix}[ Equation 5 ] & \\ {y}_{td} = \frac{1}{- L + R + 1} {\sum }_{r = L}^{R} {y}_{( t + r ) d} & ( 5 )\end{matrix}$$

The ECU 213 relating to the Local variance-Covariance matrix sequences (LC) is described. Y_{LC}=[c₁, . . . , cₜ, . . . , c_{T}] is a sequence of variance-covariance matrix in the closed interval [t+L,t+R] and the loss function LLC (Y, Y\hat{ }) of the local variance-covariance matrix is defined as the mean absolute error of the difference between Y_{LC} and Y\hat{ }_{LC} as the equation (6).

$$\begin{matrix}[ Equation 6 ] & \\ {L}_{LC} ( Y , \hat{Y} ) = \frac{1}{{TD}^{2}} {\sum }_{t = 1}^{T} {\sum }_{d = 1}^{D} {\sum }_{d = 1}^{D} [ {Y}_{LC} - {\hat{Y}}_{LC} ] & ( 6 )\end{matrix}$$

where cₜ is a variance-covariance matrix of D×D at frame t given as the equation (7).

$$\begin{matrix}[ Equation 7 ] & \\ {c}_{t} = \frac{1}{- L + R + 1} {( {Y}_{t} - {\hat{Y}}_{t} )}^{T} ( {Y}_{t} - {\hat{Y}}_{t} ) & ( 7 )\end{matrix}$$

where Y ₜ=[y ₜ₁, . . . , y _{td}, . . . , y _{tD}] is a mean vector in the closed interval [t+L, t+R].

The ECU 214 relating to the Local corRelation-coefficient matrix (LR) is described. Y_{LR}=[r₁, . . . , r^{t}, . . . , r_{T}] is a sequence of correlation coefficient matrix in the closed interval [t+L, t+R] and the loss function L_{LR}(Y,Y\hat{ }) of the local correlation-coefficient matrix is defined as the mean absolute error of the difference between Y_{LR} and Y\hat{ }LR as the equation (8).

$$\begin{matrix}[ Equation 8 ] & \\ {L}_{LR} ( Y , \hat{Y} ) = \frac{1}{{TD}^{2}} {\sum }_{t = 1}^{T} {\sum }_{d = 1}^{D} {\sum }_{d = 1}^{D} [ {Y}_{LR} - {\hat{Y}}_{LR} ] & ( 8 )\end{matrix}$$

where rₜ is a correlation-coefficient matrix given by the quotient of each element of cₜ+ε and √(vₜ^{T}vₜ+ε) and ε is a small value to prevent division by 0 (zero). When the local variance loss function L_{LV} (Y, Y\hat{ }) and the loss function LLC (Y, Y\hat{ }) of the local variance-covariance matrix are utilized concurrently, the diagonal component of cₜ overlaps with v^{t}. Therefore, the loss function defined as the equation (8) is applied to avoid the overlap.

The ECU 221 relating to the Global Variance in the sequences (GV) is described. Y_{GV}=[V₁, . . . , V_{d}, . . . , V_{D}] is the variance vector for y=Y|_{τ=0} and the loss function L_{GV} (Y,Y\hat{ }) of the global variance in the sequences is defined as the mean absolute error of the difference between Y_{GV} and Y\hat{ }_{GV} as the equation (9).

$$\begin{matrix}[ Equation 9 ] & \\ {L}_{GV} ( Y , \hat{Y} ) = \frac{1}{D} {\sum }_{d = 1}^{D} [ {Y}_{GV} - {\hat{Y}}_{GV} ] & ( 9 )\end{matrix}$$

where V_{d} is the dth variance given as the equation (10).

$$\begin{matrix}[ Equation 10 ] & \\ {V}_{d} = \frac{1}{T} {\sum }_{t = 1}^{T} {( {y}_{td} - {y}_{d} )}^{2} & ( 10 )\end{matrix}$$

where y _{d} is the dth mean given as the equation (11).

$$\begin{matrix}[ Equation 11 ] & \\ {y}_{d} = \frac{1}{T} {\sum }_{t = 1}^{T} {y}_{td} & ( 11 )\end{matrix}$$

The ECU 222 relating to the Global variance-Covariance matrix in the sequences (GC) is described. Y_{GC} is the variance-covariance matrix for y=Y|_{τ=0} and the loss function L_{GC} (Y, Y\hat{ }) of the variance-covariance matrix in the sequences is defined as the mean absolute error of the difference between Y_{GC} and Y\hat{ }_{GC} as the equation (12).

$$\begin{matrix}[ Equation 12 ] & \\ {L}_{GC} ( Y , \hat{Y} ) = \frac{1}{{D}^{2}} {\sum }_{d = 1}^{D} {\sum }_{d = 1}^{D} [ {Y}_{GC} - {\hat{Y}}_{GC} ] & ( 12 )\end{matrix}$$

where Y_{GC} is given as the equation (13).

$$\begin{matrix}[ Equation 13 ] & \\ {Y}_{GC} = \frac{1}{T} {( y - \hat{y} )}^{T} ( y - \hat{y} ) & ( 13 )\end{matrix}$$

where y =[y ₁, y _{d}, . . . , y _{D}] is a D-dimensional mean vector.

The ECU 223 relating to the Global corRelation-coefficient matrix in the sequences (GR) is described. Y_{GR} is the correlation-coefficient matrix for y=Y|_{τ=0} and the loss function L_{GR} (Y, Y\hat{ }) of the global correlation-coefficient matrix in the sequences is defined as the mean absolute error of the difference between Y_{GR} and Y\hat{ }_{GR} as the equation (14).

$$\begin{matrix}[ Equation 14 ] & \\ {L}_{GR} ( Y , \hat{Y} ) = \frac{1}{{D}^{2}} {\sum }_{d = 1}^{D} {\sum }_{d = 1}^{D} [ {Y}_{GR} - {\hat{Y}}_{GR} ] & ( 14 )\end{matrix}$$

where Y_{GR} is a correlation-coefficient matrix given by the quotient of each element of Y_{GC}+ε and √(Y_{GV}^{T} Y_{GV}+ε) and ε is a small value to prevent division by 0 (zero). When the loss function L_{GV} (Y, Y\hat{ }) of the global variance in sequences and the loss function L_{GC} (Y, Y\hat{ }) of the variance-covariance matrix in sequences are utilized concurrently, the diagonal component of Y_{GC} overlaps with the Y_{GV}. Therefore, the loss function defined as the equation (14) is applied to avoid the overlap.

The ECU 230 relating to the feature sequences of Dimensional-Domain constraints (DD) is described. Y_{DD}=yW is the sequences of features representing the relationship between dimensions and the loss function L_{DD} (Y, Y\hat{ }) of the feature sequences of Dimensional-Domain constraints is defined as the mean absolute error of the difference between Y_{DD} and Y\hat{ }_{DD} as the equation (15).

$$\begin{matrix}[ Equation 15 ] & \\ {L}_{DD} ( Y , \hat{Y} ) = \frac{1}{TN} {\sum }_{t = 1}^{T} {\sum }_{n = 1}^{N} {( {Y}_{DD} - {\hat{Y}}_{DD} )}^{2} & ( 15 )\end{matrix}$$

where W=[W₁^{T}, . . . , Wₙ^{T}, . . . , W_{N}^{T}] is a coefficient matrix that relates dimensions, Wₙ=[Wn1, . . . , W_{nd}, . . . , W_{nD}] is the nth coefficient vector, and n and N are an index and the total number of coefficient vectors, respectively.

### c4. Example 1: When the Fundamental Frequency (F₀) is Utilized for the Acoustic Feature

When the fundamental frequency (f₀) is utilized for the acoustic feature amount, the error calculation device 200 utilizes the ECU 211 relating to feature sequences of Time-Domain constraints (TD), the ECU 212 relating to the Local Variance sequences (LV) and the ECU 221 relating to the Global Variance in the sequences (GV). In this case, only the weights of the weighting units 241, 242 and 245 are set to “1” and the other weights are set to “0”. Since the fundamental frequency (f₀) is one-dimensional, a variance-covariance matrix, a correlation-coefficient matrix, and a dimensional-domain constraints are not utilized.

### c5. Example 2: When Mel-Cepstrums are Utilized for Acoustic Features

When a mel-cepstrum (a type of spectrum) is utilized as the acoustic feature amount, the error calculation device 200 utilizes the ECU 212 relating to the Local Variance sequences (LV), the ECU 213 relating to the Local variance-Covariance matrix sequences (LC), the ECU 214 relating to Local corRelation-coefficient matrix sequences (LR), the ECU 221 relating to the Global Variance in the sequences (GV) and the ECU 230 relating to feature sequences of Dimensional-Domain constraints. In this case, only the weights of the weighting units 242, 243, 244, 245 and 248 are set to “1” and the other weights are set to “0”.

### D. Examples of Speech Synthesis Apparatus

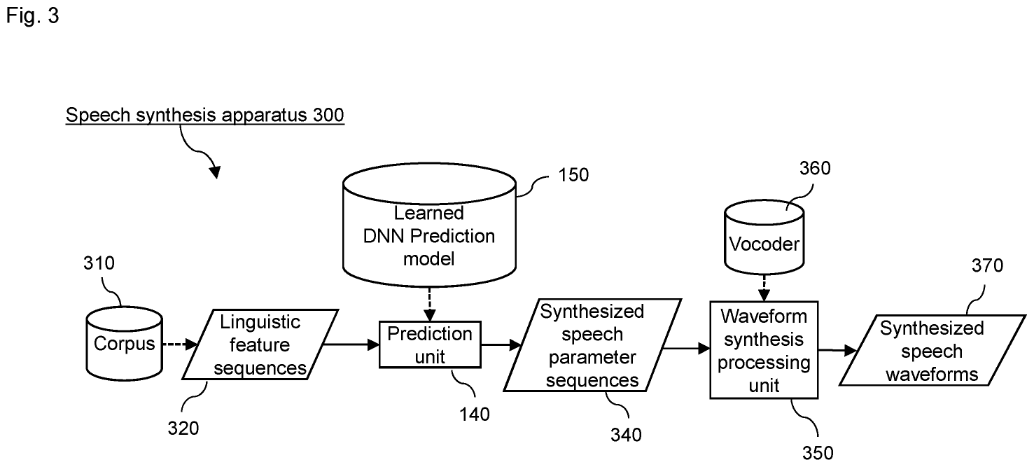

FIG. 3 is a block diagram of a speech synthesis apparatus in accordance with one or more embodiments. The speech synthesis apparatus 300 includes a corpus storage unit 310, the model storage unit 150, and a vocoder storage unit 360 as databases. The speech synthesis apparatus 300 also includes the prediction unit 140 and a waveform synthesis processing unit 350 as processing units.

The corpus storage unit 310 stores linguistic feature sequences 320 of the text to be synthesized.

The prediction unit 140 inputs the linguistic feature sequences 320, processes the sequences 320 with the learned DNN prediction model of the model storage unit 150, and outputs synthesized speech parameter sequences 340.

The waveform synthesis processing unit 350 inputs the synthesized speech parameter sequences 340, processes the sequences 340 with the vocoder of the vocoder storage unit 360 and outputs the synthesized speech waveforms 370.

### E. Speech Evaluation

### e1. Experimental Conditions

Speech corpus data of one professional female speaker in Tokyo dialect was utilized for the experiment of the speech evaluation. She spoke calmly for obtaining the corpus data. 2,000 speech units and 100 speech units were respectively extracted for learning data and evaluation data from the corpus data. The linguistic features were 527-dimensional vector sequences normalized in advance with a robust normalization method to remove outliers. Values of the fundamental frequency were extracted every frame period of 5 ms from the speech data sampled at 16 bit and 48 kHz. In a pre-processing of learning, the fundamental frequency values were logarithmic and silent and unvoiced frames were interpolated.

The embodiment used the pre-processed fundamental frequency sequences and the spectral feature sequences as the supervised data. The conventional example used the pre-processed fundamental frequency sequences concatenated with its dynamic features and the pre-processed spectral feature sequences concatenated with its dynamic features as the supervised data. Both the embodiment and the conventional example excluded the unvoiced frames from learning, calculated the means and variances from the entire learning sets and normalized both sequences. The spectral features are 60-dimensional mel-cepstrum sequences (α: 0.55). Mel-cepstrum was obtained from spectra that were extracted every frame period of 5 ms from the speech data sampled at 16 bit and 48 kHz. In addition, the unvoiced frames were excluded from learning, and the mean and variance were calculated from the entire learning sets and the mel-cepstrum was normalized.

The DNN is the FFNN that includes 512 nodes, four hidden layers and an output layer of linear activating functions. The DNN is learned by a predetermined optimization method using a method of randomly selecting the learning data that are 20 epochs and an utterance-level batch size.

The fundamental frequencies and the spectral features are modeled separately. In the conventional example, each of the loss functions are the mean squared errors of the differences between DNNs respectively relating to each of the fundamental frequencies and the spectral features. In the embodiment, the parameters of the loss function of the DNN of the fundamental frequency are L=−15, R=0, W=[[0, . . . , 0, 1], [0, . . . , 0, −20, 20]] and ω_{TD}=1, ω_{GV}=1, ω_{LV}=1 and the parameters of the loss function of the DNN of the spectral feature are L=−2, R=2, W=[[0, 0, 1, 0, 0]] ω_{TD}=1, ω_{GV}=1, ω_{LV}=3, ω_{LC}=3. In the conventional example, the parameter generation method (MLPG) generates the smooth fundamental frequency sequences from the fundamental frequency sequences concatenated with its dynamic features predicted from the DNN.

### e2. Experimental Results

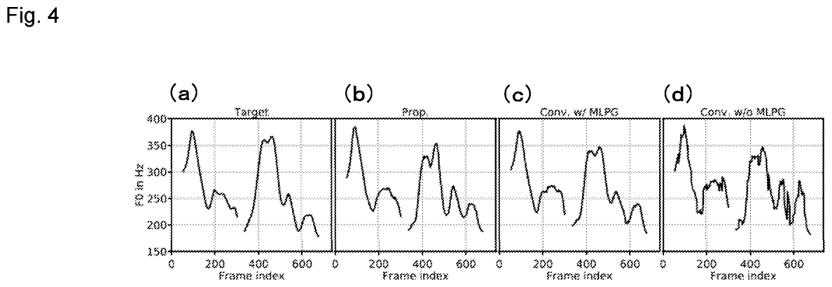

FIG. 4 shows examples (from (a) to (d)) of the fundamental frequency sequences of one utterance selected from the evaluation set utilized in the speech evaluation experiment. The horizontal axis represents the frame index and the vertical axis represents the fundamental frequency (F0 in Hz). Fig. (a) shows the F0 sequences of the target sequences, fig. (b) shows those of the method proposed by the embodiment (Prop.), fig. (c) shows those of the conventional example in which MLPG is applied (Conv. w/MLPG) and fig. (d) shows those of the conventional example in which MLPG is not applied (Conv. w/o MLPG).

Fig. (b) is smooth and has the shape of the trajectory similar to Fig. (a). Fig. (c) is smooth and has the shape of the trajectory similar to Fig.(a), too. On the other hand, Fig. (d) is not smooth and has the discontinuous shape of the trajectory. While the sequences of the embodiment are smooth without applying a post-processing to the f₀ sequences predicted from the DNN, in the conventional example post-processing MLPG needs to be applied to the f₀ sequences predicted from the DNN, in order to be smooth. Because MLPG is an utterance-level process, it can only be applied after predicting the f₀ of all frames in the utterance. MLPG needs to be applied after predicting the f₀ of all frames in the utterance, because of an utterance-level process. Therefore, MLPG is not suitable for speech synthesis systems that require low-latency.

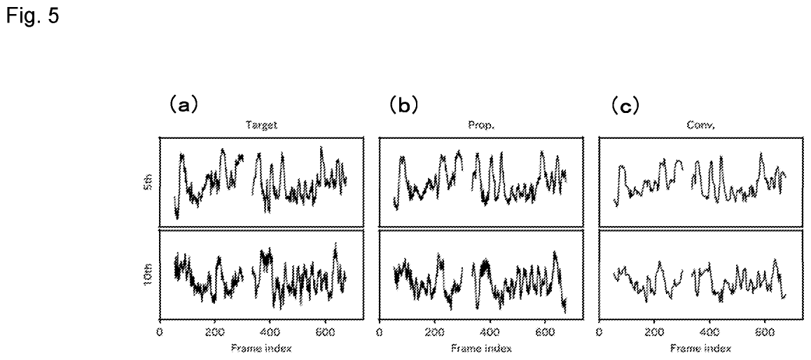

FIGS. 5 through 7 show examples of mel-cepstrum sequences of one utterance selected from the evaluation set. Fig. (a) of FIGS. 5 through 7 shows the mel-cepstrum sequences of the target sequences, fig. (b) shows those of the method proposed by the embodiment (Prop.) and fig. (c) shows those of the conventional example (Conv.).

FIG. 5 shows examples of the 5th and 10th mel-cepstrum sequences. The horizontal axis represents the frame index, the upper vertical axis (5th) represents the 5th mel-cepstrum coefficients and the lower vertical axis (10th) represents the 10th mel-cepstrum coefficients.

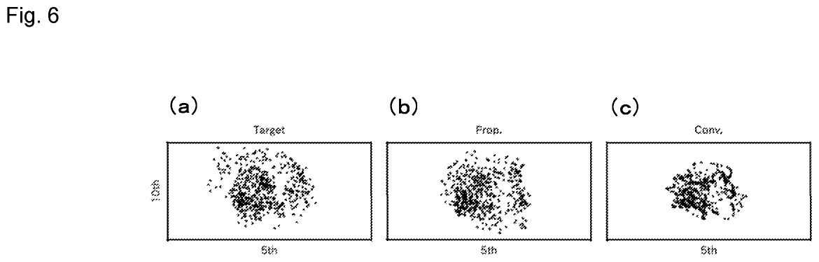

FIG. 6 shows examples of scatter diagrams of the 5th and 10th mel-cepstrum sequences. The horizontal axis (5th) represents the 5th mel-cepstrum coefficients and the vertical axis (10th) represents the 10th mel-cepstrum coefficients.

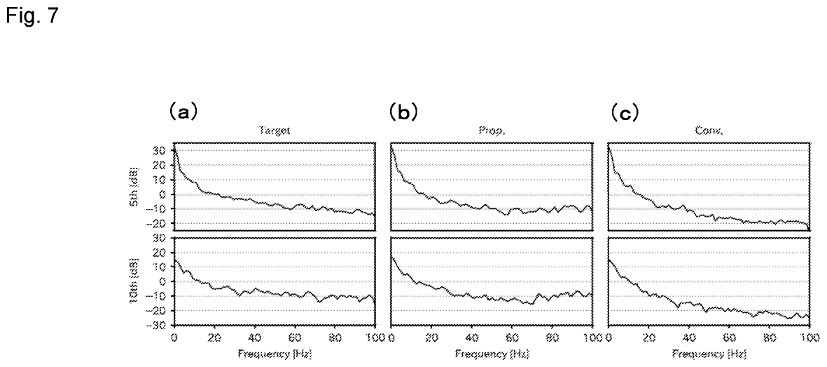

FIG. 7 shows examples of the modulation spectra of the 5th and 10th mel-cepstrum sequences. The horizontal axis represents frequency [Hz], the upper vertical axis (5th) represents the modulation spectrum [dB] of the 5th mel-cepstrum coefficients and the lower vertical axis (10th) represents the modulation spectrum [dB] of the 10th mel-cepstrum coefficients. The modulation spectrum refers to the average power spectrum of the short-term Fourier transformation.

The mel-cepstrum sequences of the conventional example and the target are compared. FIGS. 5 (a) and (c) show that the microstructure of the conventional example is not reproduced and smoothed and the variation (amplitude and variance) of the sequences of that is a little small. FIGS. 6 (a) and (c) show that the distribution of the sequences of the conventional example does not extend enough and is focused on a specific range. FIGS. 7 (a) and (c) show that the modulation spectrum above 30 Hz of the conventional example is 10 dB lower than that of the target and the high frequency component of the conventional example is not reproduced.

On the other hand, the mel-cepstrum sequences of the embodiment and the target is compared. FIGS. 5 (a) and (b) show that the sequences of the embodiment reproduce the microstructure and the variation of the embodiment is almost the same as that of the target sequences. FIGS. 6 (a) and (b) show that the distribution of the sequences of the embodiment is similar to that of the target. FIGS. 7 (a) and (b) show that the modulation spectrum from 20 Hz to 80 Hz of the embodiment is several dB lower than that of the target but is roughly the same. Therefore, the embodiment models the mel-cepstrum sequences with accuracy close to the mel-cepstrum sequences of the target sequences.

### F. Effect

The model learning apparatus 100 performs a process of calculating the error of the feature amounts of the speech parameter sequences in the short-term and long-term segments, when learning a DNN prediction model for predicting speech parameter sequences from linguistic feature sequences. The speech synthesis apparatus 300 generates synthesized speech parameter sequences 340 using the learned DNN prediction model and performs speech synthesis using a vocoder. The embodiment enables speech synthesis based on DNN that is modeled low-latency and appropriately in limited computational resource situations.

When the model learning apparatus 100 further performs error calculations related to dimensional domain constraints in addition to short-term and long-term segments, the apparatus 100 enables speech synthesis for multidimensional spectral features based on appropriately modeled DNN.

The above-mentioned embodiments (including modified examples) of the invention have been described, furthermore two or more of the embodiments may be combined. Alternatively, one of the embodiments may be partially implemented.

Furthermore, embodiments of the invention are not limited to the description of the above embodiments. Various modifications are also included in the embodiments of the invention as long as a person skilled in the art can easily conceive without departing from the description of the embodiments.

### REFERENCE SIGN LIST

100 DNN Acoustic Model Learning Apparatus
200 Error calculation Device
300 Speech Synthesis Apparatus

1. An acoustic model learning apparatus, the apparatus comprising:
a corpus storage unit configured to store natural linguistic feature sequences and natural speech parameter sequences, extracted from a plurality of speech data, per speech unit;
a prediction model storage unit configured to store a feed-forward neural network type prediction model for predicting a synthesized speech parameter sequence from a natural linguistic feature sequence;
a prediction unit configured to input the natural linguistic feature sequence and predict the synthesized speech parameter sequence using the prediction model;
an error calculation device configured to calculate an error related to the synthesized speech parameter sequence and the natural speech parameter sequence; and
a learning unit configured to perform a predetermined optimization for the error and learn the prediction model;
wherein the error calculation device is configured to utilize a loss function for associating adjacent frames with respect to the output layer of the prediction model.

2. The apparatus of claim 1, wherein
the loss function comprises at least one of loss functions relating to a time-Domain constraint, a local variance, a local variance-covariance matrix or a local correlation-coefficient matrix.

3. The apparatus of claim 2, wherein
the loss function further comprises at least one of loss functions relating to a variance in sequences, a variance-covariance matrix in sequences or a correlation-coefficient matrix in sequences.

4. The apparatus of claim 3, wherein
the loss function further comprises at least one of loss functions relating to a dimensional-domain constraint.

5. An acoustic model learning method, the method comprising:
inputting a natural linguistic feature sequence from a corpus that stores natural linguistic feature sequences and natural speech parameter sequences, extracted from a plurality of speech data, per speech unit;
predicting a synthesized speech parameter sequence using a feed-forward neural network type prediction model for predicting the synthesized speech parameter sequence from the natural linguistic feature sequence;
calculating an error related to the synthesized speech parameter sequence and the natural speech parameter sequence;
performing a predetermined optimization for the error; and
learning the prediction model;
wherein calculating the error utilizes a loss function for associating adjacent frames with respect to the output layer of the prediction model.

6. An acoustic model learning program executed by a computer, the program comprising:
a step of inputting a natural linguistic feature sequence from a corpus that stores natural linguistic feature sequences and natural speech parameter sequences, extracted from a plurality of speech data, per speech unit;
a step of predicting a synthesized speech parameter sequence using a feed-forward neural network type prediction model for predicting the synthesized speech parameter sequence from the natural linguistic feature sequence;
a step of calculating an error related to the synthesized speech parameter sequence and the natural speech parameter sequence;
a step of performing a predetermined optimization for the error; and
a step of learning the prediction model;
wherein the step of calculating the error utilizes a loss function for associating adjacent frames with respect to the output layer of the prediction model.

7. A speech synthesis apparatus, the apparatus comprising:
a corpus storage unit configured to store linguistic feature sequences of a text to be synthesized;
a prediction model storage unit configured to store a feed-forward neural network type prediction model for predicting a synthesized speech parameter sequence from a natural linguistic feature sequence, the prediction model is learned by the acoustic model learning apparatus of claim 1;
a vocoder storage unit configured to store a vocoder for generating a speech waveform;
a prediction unit configured to input the linguistic feature sequences and predict synthesized speech parameter sequences utilizing the prediction model; and
a waveform synthesis processing unit configured to input the synthesized speech parameter sequences and generate synthesized speech waveforms utilizing the vocoder.

8. A speech synthesis method, the method comprising:
inputting linguistic feature sequences of a text to be synthesized;
predicting synthesized speech parameter sequences utilizing a feed-forward neural network type prediction model for predicting a synthesized speech parameter sequence from a natural linguistic feature sequence, the prediction model is learned by the acoustic model learning method of claim 5;
inputting the synthesized speech parameter sequences; and
generating synthesized speech waveforms utilizing a vocoder for generating a speech waveform.

9. A speech synthesis program executed by a computer, the program comprising:
a step of inputting linguistic feature sequences of a text to be synthesized;
a step of predicting synthesized speech parameter sequences utilizing a feed-forward neural network type prediction model for predicting a synthesized speech parameter sequence from a natural linguistic feature sequence, the prediction model is learned by the acoustic model learning program of claim 6;
a step of inputting the synthesized speech parameter sequences; and
a step of generating synthesized speech waveforms utilizing a vocoder for generating a speech waveform.
